(19) United States
(12) Patent Application Publication
(10) Pub. No.: US 2022/0405739 A1
(43) Pub. Date: Dec. 22, 2022

(54) SYSTEM AND METHOD FOR ENHANCING THIRD PARTY SECURITY

(71) Applicant: KPMG LLP, New York, NY (US)

(72) Inventors: Saugat Sindhu, Aldie, VA (US); Romain Goy, New York, NY (US); Stephane Sbizzera, Brooklyn, NY (US); Devakumar Sarangabani, Dallas, TX (US); Thomas Haslam, Glen Rock, NJ (US); Jonathan E. Dambrot, Chester, NJ (US); Mitushi Pitti, Edison, NJ (US)

(21) Appl. No.: 17/846,974

(22) Filed: Jun. 22, 2022

Related U.S. Application Data
(60) Provisional application No. 63/213,455, filed on Jun. 22, 2021.

(51) Int. Cl. G06Q 20/38; G06Q 20/40; G06Q 20/02

(52) U.S. Cl. CPC G06Q 20/382; G06Q 20/4016; G06Q 20/02

(57) ABSTRACT

A third party security system having an intelligence unit for receiving and processing vendor related data to generate insights regarding vendor related tasks; a risk assessment unit for receiving and processing risk score data associated with the vendor and for generating a predicted risk score value of the vendor; a legal assessment unit for receiving legal data and for determining based on the legal data whether the vendor is in compliance with a contractual obligation; a vendor tiering unit for receiving the vendor related data and for classifying the vendor into one or more classes based on the vendor related data; a program quality and efficiency analysis unit for receiving the risk score data and for determining an accuracy of the risk score; and a service unit for generating a virtual agent for allowing communication with the system.

### RELATED APPLICATIONS

This application claims priority to provisional patent application Ser. No. 63/213,455, filed on Jun. 22, 2021, and entitled SYSTEM AND METHOD FOR ENHANCING THIRD PARTY SECURITY, the contents of which are herein incorporated by reference.

### BACKGROUND OF THE INVENTION

The present invention is directed to a system and method for assessing the security risk of third party vendors, and in particular is related to a system and method for performing third party security reviews and associated activities.

Businesses across all industries are increasingly compelled to rely on a robust network of third parties, including vendors, suppliers, distributors, agents, joint ventures, alliances, sub-contractors, and service providers. The third party network is important in order to maintain a global footprint and to compete effectively in the marketplace. While third parties are imperative to global operation, the various risks associated with third parties typically cannot be outsourced.

Today, companies have hundreds, even thousands, of third parties to procure, manage, and assess on a regular basis. Many companies employ a Third-Party Security (TPS) program to handle the lifecycle of their outsourced relationship and all the associated risks. Inefficiencies and gaps in the TPS programs oftentimes expose companies to issues associated with stringent regulations, competition, a changing technological landscape, and better equipped criminals. The third party risk management program analysts routinely struggle with the volume of third parties to identify. As such, the conventional processes are time-consuming, complex, and inventory issues lead to duplicates and multiple assessments being completed for the same vendor. Further, long and complex questionnaires are sent to the third party vendors, which can lead to varied answers, require constant follow-up meetings, and result in inaccurate responses to the questions. Often, vendors have already been analyzed from previous engagements and redundant work is performed, thus impeding a company's critical operating processes.

Once all answers and issues are accounted for relative to the third party vendor, the results are then analyzed and further steps, such as for example an on-site assessment, may be recommended to ensure adherence to contract requirements. Oftentimes a backlog of assessments occur, and the quality of assessments drop significantly due to a lack of time, productivity, grading consistency, and resources. Further, the reporting of the results is rarely holistic. That is, inconsistencies can appear based on the individual assessor or analyst or the geographical location of the assessment.

Further, during contract negotiations, the contract modifications submitted by vendors are often not in line with the organization's third-party requirements. As such, contract updates and provisions are not clearly communicated, monitored, and checked for compliance. In general, many companies lack a clear understanding of the contract requirements and hence do not properly manage their vendor contract relationships.

When a vendor is finally onboarded by the company, the company needs to continue to monitor and assess the vendor. Problems arise when outdated monitoring practices are not updated for changing vendor work or when industry trends are not closely followed. At the end of a contract, companies do not have clarity into how their data is being managed. In many cases, third parties maintain data and information for long periods of time, even after the contractual relationship has ended. There is a potential for data mismanagement and hence the data needs to be properly managed and monitored, which many companies fail to do. Today, companies inefficient, reactive, and poorly run third party security programs make it harder than ever to protect themselves and their customers.

Because cyber-attacks oftentimes leverage vulnerabilities in the IT systems, companies, in an effort to prevent cyber-attacks, typically invest in robust cyber security systems while concomitantly requiring third party vendors with whom they share data to maintain secure and robust cyber security systems and protocols.

Conventional approaches to ensuring that third party vendors are maintaining and performing updates to their cyber security and physical access systems involve engaging external qualified companies to perform security assessments on the third party vendor or by performing the security assessment themselves. The security assessments often times may involve a site visit as well as providing a set of written questions requesting information on the cyber security control systems employed by the vendor, and the questions oftentimes are tailored to the specific third party vendor, as well as to the requesting companies security policies and risk appetite.

A drawback of performing conventional cyber security risk assessments is that they are expensive to conduct and are time intensive. As such, for large businesses that engage many different types of third party vendors, this creates a resource issue. Further, the security risk assessments can also involve high time latency, since they may be performed on one to three year cycles because of the burdensome resource requirements of the assessments. This extended time frame to assess a vendor's security compliance is clearly inconsistent with the needs of companies that are experiencing daily cyber threats and near continual changes to their IT environments. Further, the security risk assessments lack standardization and oftentimes differ between the various external companies that are performing the security assessments.

Yet another drawback of the conventional assessment approach is that the personnel reviewing the security assessments may be assigning markedly different security risk scores relative to each other. Consequently, this makes it difficult for a business to properly assess the security compliance risk score of a specific vendor.

Still yet another drawback is that the security risk assessment ignores any associated legal requirements that may have been agreed to between the business and the vendor. As such, the security risk assessment may accidentally focus on areas that are wholly divorced from the underlying legal requirements.

### SUMMARY OF THE INVENTION

The third party security system of the present invention can significantly reduce the time required to onboard a vendor, while concomitantly providing an improved user experience throughout the TPS review and lifecycle. The system can employ one or more machine learning techniques to process incoming data to generate insights and predictions. The system can also connect the people involved in the vendor security review lifecycle and connect data silos across procurement, legal, third party security, and identity and access management, and provide intelligence/insights to ensure that relationships with third parties are known, controlled and secure. The third party security system of the present invention can thus augment or replace traditional TPS reviews.

The present invention is directed to a third party security system having an intelligence unit for receiving and processing vendor related data about a vendor to generate insights on one or more vendor related tasks; a risk assessment unit for receiving and processing risk score data associated with the vendor and for generating a predicted risk score value of the vendor; a legal assessment unit for receiving legal data and for determining based on the legal data whether the vendor is in compliance with a contractual obligation (e.g., a term or requirement of the contract); a vendor tiering unit for receiving the vendor related data and for classifying the vendor into one or more classes based on the vendor related data; a program quality and efficiency analysis unit for receiving the risk score data and for determining an accuracy of the risk score; and a service unit for generating a virtual agent for allowing communication with the system. Specifically, the virtual agent allows for the exchange of information between a vendor and an enterprise and between one or more employees of the enterprise. Further, the system can employ at least the insights on the vendor related tasks, the predicted risk score value, the determination of the compliance with the contractual obligation, and the accuracy of the risk score to enhance the data security of the enterprise.

The vendor related tasks can include two or more of: identifying one or more vendors in the vendor related data, identifying duplicate vendors in the vendor related data, generating one or more recommendations regarding selection of one or more of the vendors, identifying one or more of the vendors that are currently being utilized and sort the identified vendors based on one or more selected parameters, comparing vendors relative to each other for any discrepancies between the vendor and any associated vendor peer group, prioritizing one or more identified vendors based on one or more vendor data points, and identifying vendors based on one or more similar characteristics. The vendor data points can include accounts payable data, commercial data provider data, and security rating tools data. Further, the risk score data can include vendor profile data and vendor risk data and the risk assessment unit generates the predicted risk score based on the vendor profile data and the vendor risk data. The vendor profile data includes vendor identification information and information related to the types of goods or services supplied by the vendor.

The risk assessment unit can be configured to further generate an updated set of risk assessment questions based on the risk score data and can be configured to compare the legal data to one or more prestored security requirement templates to identify any differences. Further, the vendor related data can include one or more vendor related parameters, such as observed behaviors and predicted risks of the vendor. The vendor tiering unit can be configured to generate, in response to the vendor related data, an alert when the vendor performs one or more actions different than an approved service. The program quality and efficiency analysis unit is further configured to determine an average time to onboard the vendor.

The present invention is also directed to a computer implemented method for receiving and processing vendor related data about a vendor and then geniting insights therefrom related to one or more vendor related tasks, receiving and processing risk score data associated with the vendor and generating a predicted risk score value of the vendor, receiving legal data and generating, based on the legal data, an indication whether the vendor is in compliance with a contractual obligation, classifying the vendor into one or more classes based on the vendor related data, generating based on the risk score data an accuracy assessment of the risk score, and generating a virtual agent. The virtual agent allows for the exchange of information between a vendor and an enterprise and between one or more employees of the enterprise. The vendor related tasks can include two or more of: identifying one or more vendors in the vendor related data, identifying duplicate vendors in the vendor related data, generating one or more recommendations regarding selection of one or more of the vendors, identifying one or more of the vendors that are currently being utilized and sort the identified vendors based on one or more selected parameters, comparing vendors relative to each other for any discrepancies between the vendor and any associated vendor peer group, prioritizing one or more identified vendors based on one or more vendor data points, and identifying vendors based on one or more similar characteristics. The insights on the vendor related tasks, the predicted risk score value, the determination of the compliance with the contractual obligation, and the accuracy of the risk score can be employed to enhance the data security of the enterprise.

The vendor data points include one or more of accounts payable data, commercial data provider data, and security rating tools data. The risk score data includes vendor profile data and vendor risk data, and method further generates the predicted risk score based on the vendor profile data and the vendor risk data. The vendor profile data includes vendor identification information and information related to the types of goods or services supplied by the vendor.

The method further comprises generating an updated set of risk assessment questions based on the risk score data, comparing the legal data to one or more prestored security requirement templates to identify any differences, and generating in response to the vendor related data an alert when the vendor performs one or more actions different than an approved service. The vendor related data includes one or more vendor related parameters, and wherein the vendor related parameters includes observed behaviors and predicted risks of the vendor.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic illustration of a third party security system according to the teachings of the present invention.

FIG. 2 is a schematic flowchart diagram illustrating the methos of the present invention.

FIG. 3 is a schematic diagram of an electronic device and/or associated system suitable for implementing the process flow identification system of the present invention.

### DETAILED DESCRIPTION

The system and method of the present invention allows an enterprise to determine with reasonable assurance that the expected security controls are in place while concomitantly ensuring that a third party, such as a vendor, is complying with expected security standards of the company. Further, the present invention is directed to a system and method for supporting enterprises by establishing a robust third party security review program that is scalable and adaptable so as to meet the current business needs of the enterprise.

The third party security system of the present invention can enable and accelerate a third party security review program or assessment performed by the enterprise by using the power and scale of machine learning techniques. Specifically, the third party security system allows the enterprise to transition from a reactive to a proactive program that focuses on a risk-based approach to third party security. The system of the invention can achieve this by connecting all portions (e.g., layers) of the TPS review program, including for example governance, procurement, legal including contract management, third party security, and identity and access management. The third party security system can aggregate this information and then based on this information apply cyber and risk data analytics to provide intelligence/insights on the information to make sure that relationships with third party vendors are known, controlled and secure. The present system can thus serve to augment or if desired to replace the traditional TPS review lifecycle.

As used herein, the term “enterprise” is intended to include all or a portion of a company, a structure or a collection of structures, facility, business, company, firm, venture, joint venture, partnership, operation, organization, concern, establishment, consortium, cooperative, franchise, or group or any size. Further, the term is intended to include an individual or group of individuals, or a device or equipment of any type.

As used herein, the term “vendor” is intended to include any third party entity, enterprise, or individual that provides or offers for sale a good or service.

As used herein, the term “legal data” is intended to include any type of data that is associated with or related to a law, judgment, contract, or agreement between multiple enterprises.

As used herein, the term “machine learning: is intended to mean the application of one or more software application techniques that process and analyze data to draw inferences from patterns in the data. The machine learning techniques can include a variety of models or algorithms, including supervised learning techniques, unsupervised learning techniques, reinforcement learning techniques, knowledge-based learning techniques, natural-language-based learning techniques such as natural language generation and natural language processing, deep learning techniques, and the like. The machine learning techniques are trained using training data. The training data is used to modify and fine-tune any weights associated with the machine learning models, as well as record ground truth for where correct answers can be found within the data. As such, the better the training data, the more accurate and effective the machine learning model can be.

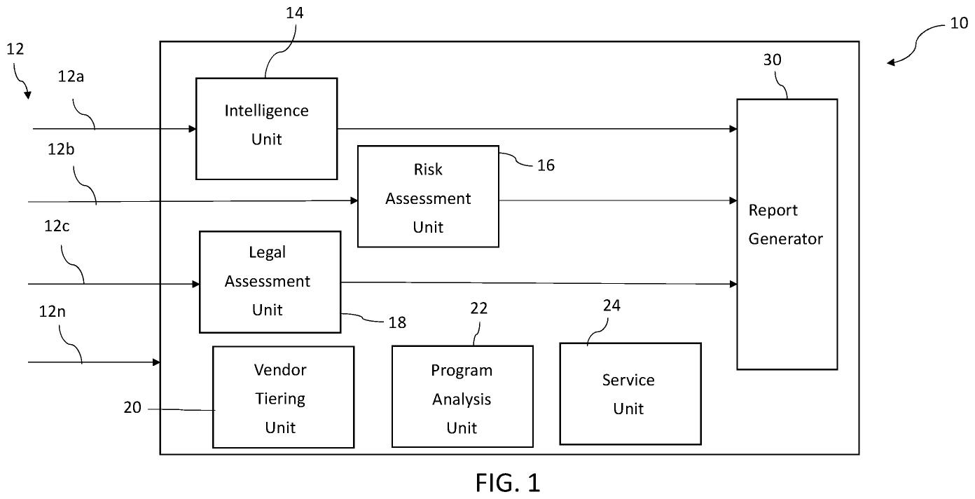

FIG. 1 is a schematic representation of the third party security system 10 of the present invention. The illustrated system 10 integrates information or data from multiple different data sources 12a-12n, and then applies one or more machine learning techniques to the combined data to extrapolate insights or predictions therefrom. The third party security system 10 can also employ a report generator 30 for generating custom reports that easily convey information in a uniform manner to the user. The aggregated data or information can come from a variety of different data sources 12a-12n, and can include for example historical and current vendor data 12a, third party risk assessment and associated risk score data 12b, legal related data 12c, and other types of data 12n.

The illustrated system 10 can receive various types of data from one or more data sources 12. The data from the data sources 12 can be optionally collated or aggregated together in a data lake or warehouse, and the system can employ an extract, transform and load (ETL) technique to extract selected types of data from the data warehouse. The data sources 12 can include a vendor data source for supplying vendor related data 12A. The vendor related data 12a can be received and processed by an intelligence module or unit 14. The intelligence unit 14 can be configured to process the vendor related data 12a by applying thereto one or more machine learning techniques and then generating insights on one or more vendor related tasks. The intelligence unit can derive or generate from the vendor related data selected insights. For example, the intelligence unit 14 can identify duplicate vendors or vendor entries in the vendor related data 12a and can propose recommendations regarding selection of one or more of the vendors. The intelligence unit can also tag or identify vendors that are currently being utilized and then sort the identified vendors based on one or more selected parameters, such as rendered services, and can then compare vendors for any discrepancies or differences between the vendor and any selected characteristic of an associated vendor peer group. The intelligence unit can also prioritize preferred vendors and based on one or more selected data points (e.g., accounts payable data, commercial data provider information, security rating tools, and the like) so as to prioritize the vendors. The system can employ a machine learning technique to search for and find vendors with similar names or that have selected attributes in common, such as revenue, country, size, and the like. Further, the vendor data source can be searchable so as to allow the intelligence unit 14 to search and hence match vendor names. The intelligence unit 14 can also be configured to analyze data generated from vendor related activity, such as for example login to the virtual private network (VPN), access to applications to determine discrepancies between the services that were approved and the observed behavior, and the like.

The third party security system 10 can also employ a risk assessment unit 16 for processing risk score data 12b received from a data source storing the risk score data and for generating a predicted risk score of the vendor. The risk score data 12b can be any type of risk score metrics that are assigned or associated with a selected vendor. The risk score data 12b can be assigned to the vendor automatically by the system based on a set of selected risk score parameters, or can be assigned to the vendor by an assessment analyst. The risk assessment unit 16 receives the risk score data 12b and can then generate, based on the data, a new or updated vendor profile and associated vendor risk score. The vendor profile can include any selected information associated with the vendor, such as vendor identification information (e.g., name), the types of goods or services supplied by the vendor, and any utilization information associated with the vendor including the frequency of use of the vendor by the enterprise. The vendors can be assigned to classes or groups based on similar characteristics (e.g., types of services, location, and the like). Thus, based on previous responses and associated peer group scores in the risk score data 12b, the risk assessment unit 16 can generate an updated (e.g., revised) security questionnaire employed during the TPS review process based on previous assessment results and industry risk scores and peer group results, and can then generate vendor risk prediction scores based on the previous assessment results and any vendor-provided information, such as updated document information in the risk score data 12b. The risk assessment unit 16 can also be configured to analyze previous assessment data related to the vendor, and which can be stored in the vendor database, on the same vendor or vendors that are considered as peers. The risk assessment unit 16 can then employ a machine learning technique to predict the risk rating or score of an engagement with the vendor based on the analyzed risk score data 12b.

The system can also include a legal assessment unit 18 for analyzing any legal data 12c associated with the vendors and directed to any contractually negotiated services of the vendors, and for analyzing other legal data associated with vendors that provide similar services. The legal data can be prestored at a selected location and then processed by a selected machine learning technique so as to recognize the data. The legal assessment unit 18 can process the legal data 12c to determine, for example, whether the vendor is in compliance with a contractual obligation, whether the vendor meets a client's standard for information security, as well as whether the vendor is performing the contractually obligated services. The legal assessment unit 18 can then determine if the vendor is in compliance by applying a selected machine learning technique to the legal data 12c and through an analysis of data transmission patterns, access points, and other information sources. The legal assessment unit 18 can also analyze the legal data 12c by comparing the data to one or more prestored security requirement templates and then identifying any differences, and then identifying the differences as potential vendor risk issues.

The third party security system 10 can further include a vendor tiering unit 20 receiving and processing vendor related data and then for automatically classifying vendors into one or more tiers or classes based on one or more vendor related parameters by applying a machine learning technique thereto. The parameters can include, for example, logical access and observed behaviors and predicted risks, and then can provide or generate in response real time alerts when the vendor performs one or more actions outside the scope of any approved service. The predicted risks can be based on historical vendor specific data and historical data related to other vendors considered to be peers.

The system can further include a program quality and efficiency analysis unit 22 for analyzing the risk score data 12b and then providing or generating insights or predictions into each assessor's performance and/or accuracy during the risk score generation phase and for determining an average time to onboard vendors across one or more geographic or technology regions or areas. Specifically, according to one practice, an assessor or analyst can perform an assessment of one or more vendors and then assign a risk score to the vendor based on a series or set of factors. The assessment can include, for example, a questionnaire having a series of questions that the vendor can complete or are asked of the vendor. The program quality and efficiency analysis unit 22 can analyze the risk score data from the vendor assessments. The insights on the vendor related tasks, the predicted risk score value, the determination of the compliance with the contractual obligation, and the accuracy of the risk score can be employed by the system to enhance the data security of the enterprise.

The third party security system 10 can also include a service unit 24 for employing one or more machine learning techniques for generating and utilizing a digital worker, such as a chat bot or virtual agent. The chat bot allows for interactions between businesses, third party vendors, and third party security analysts. The service module can also be the main point of entry to the TPS review process. The service module 24 can employ chatbot technologies and natural language processing techniques to answer less complex questions that the business stakeholders would have asked a human from the third party security team.

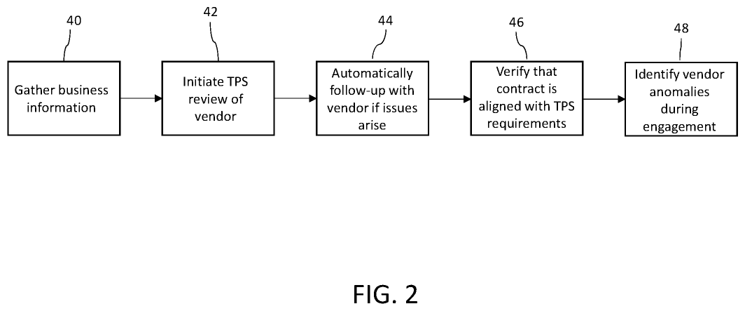

According to the method of the present invention, as shown for example in FIG. 2, the third party security system 10 can initially receive and gather information about a selected business need of the organization, step 40. The system can then identify and recommend a vendor from a list of vendors to meet the business need or can allow the business to identify a specific vendor. Based on this data, the system 10 can assign a risk level to the engagement and then contact the vendor to initiate the TPS review, which can include providing a security questionnaire, step 42. The questionnaire is employed to gather required information such that the system can assess risk attributes of the vendor, such as type of services supplied, geographic location, specific contracts in place, and the like. The vendor can be assigned an initial risk score or rating by the system or by the analyst. The analyst or the system can then automatically follow-up with the vendor on selected issues as they arise, such as via the virtual agent, step 44. The system can further conduct if desired additional due diligence, including site assessments or visits, financial reviews, integrity due diligence review, and the like. The system 10 can then update the risk score assigned to the vendor based on the additional due diligence. The system 10 can then analyze any legal data set forth in any related contract covering the services to be provided by the vendor to ensure that the contract is aligned with TPS requirements, step 46. If no contract is in place, then the system can aggregate together the resulting contract between the business and the vendor. The system can analyze the strength and clarity of contract terms, and can analyze the contract to determine if selected provisions are present within the contract, such as information technology and cyber security provisions. The system can then monitor the vendor during the business engagement to identify any anomalies that arise, such as for example departure from stated services, failure to fulfill contracted services, changes in the business, and the like, step 48.

The third party security system 10 of the present invention can significantly reduce the time required to onboard a vendor, while providing an improved user experience throughout the TPS review and lifecycle. The system can employ one or more machine learning techniques, incorporated as part of one or more of the intelligence unit 14, the risk assessment unit 16, the legal assessment unit 18, the vendor tiering unit 20, and the program analysis unit 22 to process incoming data to generate insights and predictions. The system can also connect the people involved in the vendor security review lifecycle and connect data silos across procurement, legal, third party security, and identity and access management, and provide intelligence/insights to ensure that relationships with third parties are known, controlled and secure. The third party security system 10 of the present invention can thus augment or replace traditional TPS reviews.

The system 10 of the present invention can also be deployed to automate and make more consistent the vendor onboarding process for the enterprise. The system achieves these advantages by employing a digital worker to collect information from the vendors, employ machine learning techniques to analyze the answers and responses by the vendor to on-boarding or security questionnaires and then compare the answers to policy documents, the ability not generate a vendor risk score, employing one or more machine learning techniques to review legal data and to monitor the vendor performance and to adjust the vendor risk score over time. The system thus enables information to be consistently collected and re-used across different points in the vendor lifecycle.

The present invention can be employed to solve TPS review issues typically experienced by businesses. We provide below an illustrative example.

### Example A

A business has an exemplary problem, such as how best to handle a cumbersome questionnaire used by a third party security team, and how best to follow through on the questionnaire. The questionnaire requires a significant increase in support time from the TPS team to ensure that enough details are captured in the early stage of the information gathering process in order to best assess the third party vendors security risk. The interactions with the vendor oftentimes require several back-and-forth sessions, which is time intensive. As such, the business spends time unnecessarily on easy/low-value follow-ups.

As part of the solution, the system and method of the present invention can employ a digital worker (e.g., a chatbot or virtual agent) to manage the end-to-end process of onboarding the vendor. For example, the virtual agent can gather information from the business. Once the information is gathered, the system can detect or identify duplicate vendor information, categorize the nature of the work to be performed, recommend preferred third party vendors, and provide initial risk categorization or scoring based on this information from the business and incorporating other available data (e.g., previous assessments of the vendor, continuous monitoring data, and the like).

Next, the virtual agent can drive or handle the initial conversation between the business and the third party vendor. The virtual agent can initially gather information from the business side, forward preselected questions to the third party vendor based on the risks it poses to the organization and peers, analyze the vendor answers, adapt questionnaire on the fly, identify failed or incomplete answers, and then request follow-up answers from the vendor.

It is to be understood that although the invention has been described above in terms of particular embodiments, the foregoing embodiments are provided as illustrative only, and do not limit or define the scope of the invention. Various other embodiments, including but not limited to those described herein are also within the scope of the claims. For example, elements, modules, units, tools and components described herein may be further divided into additional components or joined together to form fewer components for performing the same functions. Further, selected user interfaces (e.g., windows or screens) can be generated by any selected portion or unit of the system 10, such as for example, by the report generator 30. Further, any of the functions disclosed herein may be implemented using means for performing those functions. Such means include, but are not limited to, any of the components disclosed herein, such as the electronic or computing device components described herein.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

The term computing device or electronic device can refer to any device that includes a processor and a computer-readable memory capable of storing computer-readable instructions, and in which the processor is capable of executing the computer-readable instructions in the memory. The terms computer system and computing system refer herein to a system containing one or more computing devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which could not be solved manually or mentally by humans.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to automate third party security reviews and to integrate disparate sources of data. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

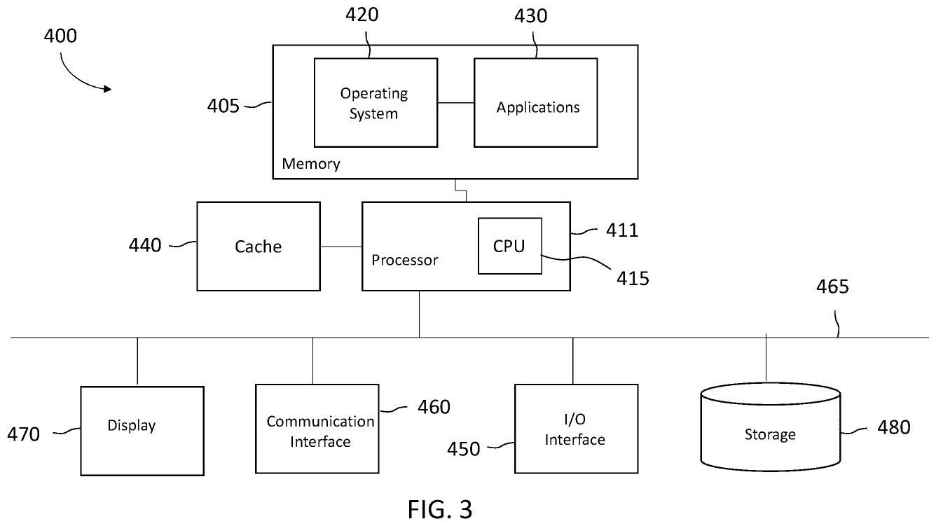

It should be appreciated that various concepts, systems and methods described above can be implemented in any number of ways, as the disclosed concepts are not limited to any particular manner of implementation or system configuration. Examples of specific implementations and applications are discussed below and shown in FIG. 3 primarily for illustrative purposes and for providing or describing the operating environment of the system of the present invention. The third party security system 10 and/or any elements, components, or units thereof can employ one or more electronic or computing devices, such as one or more servers, clients, computers, laptops, smartphones and the like, that are networked together or which are arranged so as to effectively communicate with each other. The network can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the electronic or computing device 400. The present invention can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 400. In one embodiment, the server may be referred to as a remote machine or a node. In another embodiment, a plurality of nodes may be in the path between any two communicating servers or clients. The third party security system 10 can be stored on one or more of the clients or servers, and the hardware associated with the client or server, such as the processor or CPU and memory described below.

FIG. 3 is a high-level block diagram of an electronic or computing device 400 that can be used with the embodiments disclosed herein. Without limitation, the hardware, software, and techniques described herein can be implemented in digital electronic circuitry or in computer hardware that executes firmware, software, or combinations thereof. The implementation can include a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 400 can be any suitable electronic circuitry that includes a main memory unit 405 that is connected to a processor 411 having a CPU 415 and a cache unit 440 configured to store copies of the data from the most frequently used main memory 405. The electronic device can implement the process flow identification system 10 or one or more elements of the process flow identification system.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 411 is any logic circuitry that responds to, processes or manipulates instructions received from the main memory unit, and can be any suitable processor for execution of a computer program. For example, the processor 411 can be a general and/or special purpose microprocessor and/or a processor of a digital computer. The CPU 415 can be any suitable processing unit known in the art. For example, the CPU 415 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 411 can be embodied in any suitable manner. For example, the processor 411 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 411 can be configured to execute instructions stored in the memory 405 or otherwise accessible to the processor 411. As such, whether configured by hardware or software methods, or by a combination thereof, the processor 411 can represent an entity (e.g., physically embodied in circuitry) capable of performing operations according to embodiments disclosed herein while configured accordingly. Thus, for example, when the processor 411 is embodied as an ASIC, FPGA or the like, the processor 411 can be specifically configured hardware for conducting the operations described herein. Alternatively, as another example, when the processor 411 is embodied as an executor of software instructions, the instructions can specifically configure the processor 411 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 405.

The electronic device 400 applicable to the hardware of the present invention can be based on any of these processors, or any other processor capable of operating as described herein. The central processing unit 415 may utilize instruction level parallelism, thread level parallelism, different levels of cache, and multi-core processors. A multi-core processor may include two or more processing units on a single computing component. Examples of multi-core processors include the AMD PHENOM IIX2 and IIX4, INTEL CORE i5, INTEL CORE i7, and INTEL CORE i9.

The processor 411 and the CPU 415 can be configured to receive instructions and data from the main memory 405 (e.g., a read-only memory or a random access memory or both) and execute the instructions The instructions and other data can be stored in the main memory 405. The processor 411 and the main memory 405 can be included in or supplemented by special purpose logic circuitry. The main memory unit 405 can include one or more memory chips capable of storing data and allowing any storage location to be directly accessed by the processor 411. The main memory unit 405 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 405 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 405 can be based on any of the above described memory chips, or any other available memory chips capable of operating as described herein. In the embodiment shown in FIG. 3, the processor 411 communicates with main memory 405 via a system bus 465. The computer executable instructions of the present invention may be provided using any computer-readable media that is accessible by the computing or electronic device 400. Computer-readable media may include, for example, the computer memory or storage unit 405. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 405 is shown within the computing device 400 it will be appreciated that the storage may be distributed or located remotely and accessed via a network or other communication link.

The main memory 405 can comprise an operating system 420 that is configured to implement various operating system functions. For example, the operating system 420 can be responsible for controlling access to various devices, memory management, and/or implementing various functions of the asset management system disclosed herein. Generally, the operating system 420 can be any suitable system software that can manage computer hardware and software resources and provide common services for computer programs.

The main memory 405 can also hold application software 430. For example, the main memory 405 and application software 430 can include various computer executable instructions, application software, and data structures, such as computer executable instructions and data structures that implement various aspects of the embodiments described herein. For example, the main memory 405 and application software 430 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 411 can further be coupled to a database or data storage 480. The data storage 480 can be configured to store information and data relating to various functions and operations of the content characterization systems disclosed herein. For example, as detailed above, the data storage 480 can store information including but not limited to captured information, multimedia, processed information, and characterized content.

A wide variety of I/O devices may be present in or connected to the electronic device 400. For example, the electronic device can include a display 470, and the report generator 30 of the system 10 can include the display. The display 470 can be configured to display information and instructions received from the processor 411. Further, the display 470 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 470 can be a smart and/or touch sensitive display that can receive instructions from a user and forwarded the received information to the processor 411. The input devices can also include user selection devices, such as keyboards, mice, trackpads, trackballs, touchpads, touch mice, multi-touch touchpads, touch mice and the like, as well as microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 400 can also include an Input/Output (I/O) interface 450 that is configured to connect the processor 411 to various interfaces via an input/output (I/O) device interface 480. The device 400 can also include a communications interface 460 that is responsible for providing the circuitry 400 with a connection to a communications network (e.g., communications network 120). Transmission and reception of data and instructions can occur over the communications network.

1. A security system for enhancing data security of an enterprise, comprising an intelligence unit for receiving and processing vendor related data to generate insights on one or more vendor related tasks,
a risk assessment unit for receiving and processing risk score data associated with a vendor and for generating a predicted risk score associated with the vendor,
a legal assessment unit for receiving legal data and for determining based on the legal data whether the vendor is in compliance with a contractual obligation,
a vendor tiering unit for receiving the vendor related data and for classifying the vendor into one or more classes based on the vendor related data,
a program quality and efficiency analysis unit for receiving the risk score data and for determining based on the risk score data an accuracy of the risk score, and
a service unit for generating a virtual agent, wherein the virtual agent allows for the exchange of information between a vendor and the enterprise and between one or more employees of the enterprise,
wherein at least the insights on the vendor related tasks, the predicted risk score, the determination of the compliance with the contractual obligation, and the accuracy of the risk score are employed to enhance the data security of the enterprise.

2. The system of claim 1, wherein the vendor related tasks include two or more of:
identifying one or more vendors in the vendor related data,
identifying duplicate vendors in the vendor related data,
generating one or more recommendations regarding selection of one or more of the vendors,
identifying one or more of the vendors that are currently being utilized and sorting the identified vendors based on one or more selected parameters,
comparing vendors relative to each other for any discrepancies between the vendor and any associated vendor peer group,
prioritizing one or more identified vendors based on one or more vendor data points, and
identifying vendors based on one or more similar characteristics.

3. The system of claim 2, wherein the vendor data points include one or more of accounts payable data, commercial data provider data, and security rating tools data.

4. The system of claim 2, wherein the risk score data includes vendor profile data and vendor risk data, and wherein the risk assessment unit generates the predicted risk score based on the vendor profile data and the vendor risk data.

5. The system of claim 4, wherein the vendor profile data includes vendor identification information and information related to the types of goods or services supplied by the vendor.

6. The system of claim 4, wherein the risk assessment unit further generates an updated set of risk assessment questions based on the risk score data.

7. The system of claim 4, wherein the legal assessment unit compares the legal data to one or more prestored security requirement templates to identify any differences.

8. The system of claim 7, wherein the vendor related data includes one or more vendor related parameters, and wherein the vendor related parameters include observed behaviors and predicted risks of the vendor.

9. The system of claim 8, wherein the vendor tiering unit generates in response to the vendor related data an alert when the vendor performs one or more actions different than an approved service.

10. The system of claim 9, wherein the program quality and efficiency analysis unit is further configured to determine an average time to onboard the vendor.

11. A computer implemented method for enhancing data security of an enterprise, comprising
receiving and processing vendor related data about a vendor and then geniting insights therefrom related to one or more vendor related tasks,
receiving and processing risk score data associated with the vendor and generating a predicted risk score value of the vendor,
receiving legal data and generating, based on the legal data, an indication whether the vendor is in compliance with a contractual obligation,
classifying the vendor into one or more classes based on the vendor related data,
generating based on the risk score data an accuracy assessment of the risk score, and
generating a virtual agent, wherein the virtual agent allows the exchange of information between a vendor and an enterprise and between one or more employees of the enterprise,
wherein at least the insights on the vendor related tasks, the predicted risk score value, the determination of the compliance with the contractual obligation, and the accuracy of the risk score are employed to enhance the data security of the enterprise.

12. The computer implemented method of claim 11, wherein the vendor related tasks include two or more of:
identifying one or more vendors in the vendor related data,
identifying duplicate vendors in the vendor related data,
generating one or more recommendations regarding selection of one or more of the vendors,
identifying one or more of the vendors that are currently being utilized and sort the identified vendors based on one or more selected parameters,
comparing vendors relative to each other for any discrepancies between the vendor and any associated vendor peer group,
prioritizing one or more identified vendors based on one or more vendor data points, and
identifying vendors based on one or more similar characteristics.

13. The computer implemented method of claim 11, wherein the vendor data points include one or more of accounts payable data, commercial data provider data, and security rating tools data.

14. The computer implemented method of claim 12, wherein the risk score data includes vendor profile data and vendor risk data, further comprising generating the predicted risk score based on the vendor profile data and the vendor risk data.

15. The computer implemented method of claim 14, wherein the vendor profile data includes vendor identification information and information related to the types of goods or services supplied by the vendor.

16. The computer implemented method of claim 14, further comprising generating an updated set of risk assessment questions based on the risk score data.

17. The computer implemented method of claim 14, further comprising comparing the legal data to one or more prestored security requirement templates to identify any differences.

18. The computer implemented method of claim 17, wherein the vendor related data includes one or more vendor related parameters, and wherein the vendor related parameters includes observed behaviors and predicted risks of the vendor.

19. The computer implemented method of claim 18, further comprising generating in response to the vendor related data an alert when the vendor performs one or more actions different than an approved service.

20. The computer implemented method of claim 19, wherein the program quality and efficiency analysis unit is further configured to determine an average time to onboard the vendor.
